(19) United States
(12) Patent Application Publication
(10) Pub. No.: US 2006/0045182 A1
(43) Pub. Date: Mar. 2, 2006

(54) Encoding device, decoding device, encoding method, decoding method, and program therefor

(75) Inventor: Taro Yokose, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/081,730

(22) Filed: Mar. 17, 2005

(30) Foreign Application Priority Data
Sep. 1, 2004 (JP) P.2004-254084

(51) Int. Cl. H04N 7/12; H04N 11/04; H04B 1/66; H04N 11/02

(52) U.S. Cl. 375/240.12

(57) ABSTRACT

An encoding device to encode data of a motion picture made of a plurality of frame images, the encoding device includes a reference information generating unit, based on image data of a frame image of notice to be encoded, to generate reference information with respect to another frame image different from the frame image of notice, and a code generating unit to generate code data of the reference information generated by the reference information generating unit as code data of at least a portion of the frame image of notice.

### BACKGROUND OF THE INVENTION

1. Field of the Invention

The present invention relates to an encoding device and a decoding device which adopt a predictive coding scheme.

2. Description of the Related Art

As an encoding method with a self correlation of data, for example, run-length encoding, JPEG-LS, LZ encoding (Ziv-Lempel encoding), and so on are known. In particular, in the case of image data, adjacent pixels have a high correlation, and thus image data can be encoded with high compression rate.

Further, JP-A-11-313326 discloses an image data compressing device which, with a correlation between frames constituting a motion picture, calculates differential image data between the frames, and selectively compresses and encodes calculated differential image data and input image data (a frame image).

### SUMMARY OF THE INVENTION

The present invention has been made under the above-described background, and the present invention provides an encoding device which effectively encodes input image with a correlation between images or a decoding device which decodes code data encoded by the encoding device, and provides an encoding device which encodes an input image and controls an access to encrypted information included in the input image and a decoding device which decodes code data encoded by the encoding device.

According to an aspect of the present invention, an encoding device to encode data of a motion picture made of a plurality of frame images includes a reference information generating unit, based on image data of a frame image of notice to be encoded, to generate reference information with respect to another frame image different from the frame image of notice, and a code generating unit to generate code data of the reference information generated by the reference information generating unit as code data of at least a portion of the frame image of notice.

### BRIEF DESCRIPTION OF THE DRAWINGS

Embodiments of the present invention will be described in detail based on the following figures, wherein:

FIGS. 1A and 1B are diagrams illustrating a difference between an encoding scheme accompanied with the generation of a differential image and an encoding scheme in an embodiment, and specifically, FIG. 1A exemplarily shows a differential image between a previous frame and a current frame and FIG. 1B exemplarily shows reference positions which are referred to at the time of the generation of prediction data in the embodiment;

FIG. 2 is a diagram exemplarily showing a hardware configuration of an image processing device 2 to which an encoding method and a decoding method according to the present invention are applied, with laying emphasis on a control device 21;

FIG. 3 is a diagram exemplarily showing a functional configuration of a first encoding program 5 which is executed by the control device 21 (FIG. 2) and realizes the encoding method according to the present invention;

FIGS. 4A to 4C are diagrams illustrating an encoding process which is executed by the encoding program 5, and specifically, FIG. 4A exemplarily shows positions of pixels which are referred to by an in-frame prediction unit 510 and an inter-frame prediction unit 520, FIG. 4B exemplarily shows codes associated with the respective reference pixels, and FIG. 4C exemplarily shows code data generated by the encoding program 5;

FIGS. 5A to 5C are diagrams illustrating reference positions which are set according to movements of an object;

FIGS. 6A to 6C are diagrams illustrating the reference positions set in a zoomed scene;

FIG. 7 is a flowchart illustrating an operation of an encoding process (S10) by the encoding program 5;

FIG. 8 is a diagram exemplarily showing a functional configuration of a decoding program 6 which is executed by the control device 21 (FIG. 2) and realizes a decoding program according to the present invention;

FIG. 9 is a diagram exemplarily showing a functional configuration of a second encoding program 52;

FIG. 10 is a diagram exemplarily showing a functional configuration of a quantization unit 580;

FIG. 11 is a flowchart illustrating an operation of an encoding process (S20) by the second encoding program 52;

FIGS. 12A to 12C are diagrams exemplarily showing quantized image data (a quantized image), and specifically, FIG. 12A exemplarily shows a case in which an ideal input image is quantized with a pixel value of a preceding pixel, FIG. 12B exemplarily shows a case in which an input image including noise is quantized with the pixel value of the preceding pixel, and FIG. 12C exemplarily shows a case in which the input image including noise is quantized with a mean pixel value of a group of pixels;

FIGS. 13A to 13C are diagrams illustrates an encoding method of frames having a layer structure, and specifically, FIG. 13A exemplarily shows the frames having the layer structure, FIG. 13B illustrates an method in which plural frames having the layer structure are encoded in a single stream, and FIG. 13C illustrates a method in which plural frames having the layer structure are encoded in a multi-stream;.

FIG. 14 is a diagram illustrating an encoding process to which an interlayer prediction is applied;

FIG. 15 is a diagram illustrating an encoding process of a document file having plural pages;

FIG. 16 is a diagram exemplarily showing a functional configuration of an encoding program 54 in a second embodiment; and

FIG. 17A is a diagram illustrating en encoding process of a three-dimensional (3D) motion picture and FIG. 17B is a diagram illustrating an encoding process which executes an encryption process to the motion picture.

### DETAILED DESCRIPTION OF THE INVENTION

[Encoding Device]

There is provided an encoding device according to the present invention to encode data of a motion picture made of plural frame images. The encoding device includes a reference information generating unit, based on image data of a frame image of notice to be encoded, to generate reference information with respect to another frame image different from the frame image of notice, and a code generating unit to generate code data of the reference information generated by the reference information generating unit as code data of at least a portion of the frame image of notice.

Preferably, when encoding an area of notice of the frame image of notice, the reference information generating unit further generates reference information with respect to another area on the frame image of notice different from the area of notice, and the code generating unit generates code data of the reference information with respect to another area on the frame image of notice or code data of the reference information with respect to another frame image, as code data of the area of notice.

Preferably, the encoding device further includes a reference position setting unit to set a reference position with respect to another frame image according to the frame image of notice. Further, based on image data of the reference position set by the reference position setting unit and image data of the area of notice in the frame image of notice, the reference information generating unit generates reference information with respect to the reference position.

Preferably, the reference position setting unit changes the number of the reference positions according to the area of notice in the frame image of notice, and the reference information generating unit selects one reference position among at least one reference position set by the reference position setting unit based on image data of the area of notice and image data of the reference position, and generates reference information with respect to the selected reference position.

Preferably, the reference position setting unit changes the reference position in another frame image according to the area of notice in the frame image of notice, and, based on image data of the reference position set by the reference position setting unit and image data of the area of notice in the frame image of notice, the reference information generating unit generates the reference information with respect to the reference position.

Preferably, according to a difference between the frame image of notice and another frame image whose reference position is set, the reference position setting unit sets the reference position in another frame image.

Preferably, the reference information generating unit compares image data of the area of notice in the frame image of notice to image data of a reference position in another frame image and, when a difference between image data of the area of notice and image data of the reference position falls within a predefined tolerance, generates reference information with respect to the reference position, and the code generating unit generates code data of the reference information generated by the reference information generating unit as code data of the area of notice.

Preferably, the reference information generating unit compares image data of the area of notice in the frame image of notice to image data of another area in the frame image of notice and, when a difference between image data of the area of notice and image data of another area falls within a predefined tolerance, generates reference information with respect to another area, and the tolerance with respect to the difference between image data of the area of notice in the frame image of notice and image data of the reference position in another frame image is different from the tolerance with respect to the difference between image data of the area of notice and image data of another area in the frame image of notice.

Preferably, the encoding device further includes a data substituting unit to compare image data of the area of notice in the frame image of notice to image data of the reference position in another frame image and, when the difference between image data of the area of notice and image data of the reference position falls within the predefined tolerance, to substitute image data of the area of notice with image data of the reference position.

Preferably, the encoding device further includes a data substituting unit to substitute image data of the area of notice with a statistical value of image data of the reference position when the difference between image data of the area of notice and image data of the reference position of another frame image among the plural frame images consecutively falls within the predefined tolerance.

Preferably, each of the frame images has at least a first layer image and a second layer image. Further, when encoding the first layer image constituting the frame image of notice, the reference information generating unit generates reference information with respect to a first layer image constituting another frame image, and the code generating unit generates code data of the reference information with respect to the first layer image constituting another frame image as code data of at least a portion of the first layer image constituting the frame image of notice.

Further, there is provided an encoding device according to the present invention to encode data of a document file including plural page images. The encoding device includes a reference information generating unit, based on image data of a page image to be encoded, to generates reference information with respect to a reference image different from the page image, and a code generating unit to generate code data of the reference information generated by the reference information generating unit as code data of at least a portion of the page image.

Preferably, the reference image is another page image different from the page image to be encoded, the reference information generating unit generates reference information with respect to another page image, and the code generating unit generates code data of the reference information with respect to another page image as code data of at least a portion of the page image to be encoded.

Preferably, the reference image is a common object image which commonly exists in the plural page images, the reference information generating unit generates reference information with respect to the common object image, and the code generating unit generates code data of the reference information with respect to the common object image as code data of at least a portion of the page image to be encoded.

[Decoding Device]

Further, there is provided a decoding device according to the present invention to decode code data of a motion picture made of plural frame images. The decoding device includes a reference data extracting unit, based on code data of a frame image of notice, to refer to another frame image different from the frame image of notice and to extract image data included in another frame image, and an image data generating unit, based on image data extracted by the reference data extracting data, to generate image data of at least a portion of the frame image of notice.

[Encoding Method]

Further, there is provided an encoding method according to the present invention to encode data of a motion picture made of plural frame images. The encoding method includes a step of, based on image data of a frame image of notice to be encoded, generating reference information with respect to another frame image different from the frame image of notice, and a step of generating code data of the generated reference information as code data of at least a portion of the frame image of notice.

[Decoding Method]

Further, there is provided a decoding method according to the present invention to decode code data of a motion picture made of plural frame images. The decoding method includes a step of, based on code data of a frame image of notice, referring to another frame image different from the frame image of notice and extracting image data included in another frame image, and a step of, based on extracted image data, generating image data of at least a portion of the frame image of notice.

[Program]

Further, there is provided a program according to the present invention which causes an encoding device to encode data of a motion picture made of plural frame images to execute a step of, based on image data of a frame image of notice to be encoded, generating reference information with respect to another frame image different from the frame image of notice, and a step of generating code data of the generated reference information as code data of at least a portion of the frame image of notice.

Further, there is provided a program according to the present invention which causes a decoding device to decode code data of a motion picture made of plural frame images to execute a step of, based on code data of a frame image of notice, referring to another frame image different from the frame image of notice and extracting image data included in another frame image, and a step of, based on extracted image data, generating image data of at least a portion of the frame image of notice.

According to an encoding device of the present invention, an input image can be effectively encoded with a correlation between images.

In order to assist in understanding the present invention, the background and the summary of the present invention will be described.

For example, in predictive encoding schemes such as LZ encoding schemes or the like, prediction data is generated by referring to a pixel value of a predefined reference position and, when generated prediction data matches with image data of a pixel of notice, the reference position or the like (hereinafter, referred to as reference information) of matched prediction data is encoded as code data of the pixel of notice. For this reason, the higher the matching frequency (hitting ratio) of prediction data is, the more the high compression rate can be expected. Therefore, in the predictive encoding scheme, depending on where the reference position is set, compression efficiency drastically changes. In general, since adjacent pixels have the high correlation, the reference position is set with respect to a pixel (on the same image) adjacent to the pixel of notice.

Further, in JPEG-LS schemes (non-reciprocal mode) or the like, a pixel value of a succeeding pixel is substituted with a pixel value determined with respect to a preceding pixel, and thus the hitting ratio of prediction data further increases, thereby enhancing the compression rate.

As an input image to be encoded, there also are images which constitute plural image groups having the correlation. For example, plural frame images constituting a motion picture substantially matches with each other in a static image area. Further, in a motion image area, it is to be understood that, when considering the movement direction and the movement amount, the plural frame images have the correlation to some degree.

Therefore, according to the present invention, when encoding an input image (an object image) to be encoded, an image processing device generates prediction data by referring to at least another reference image (for example, another frame image) and performs a predictive encoding process with generated prediction data. Specifically, the present image processing device encodes reference information with respect to another reference image as code data of at least a portion of the object image.

Further, when decoding code data generated in such a manner, the present image processing device refers to another reference image according to code data and generates a decoded image with image data included in the reference image.

Moreover, according to the method described in JP-A-11-313326, when encoding a current frame to be coded, a differential image between the current frame and a previous frame (a base image) is generated.

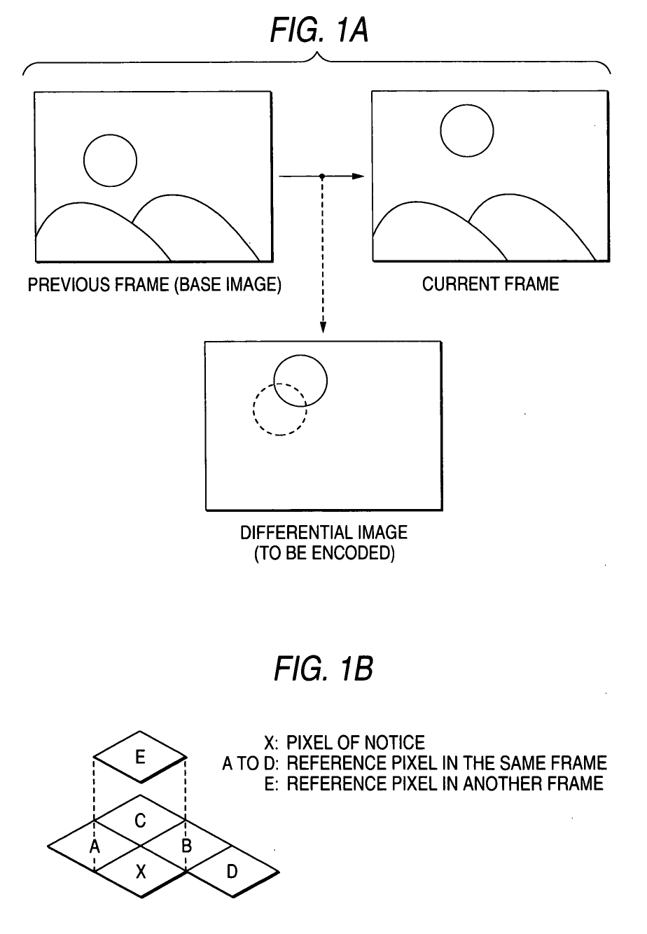

FIGS. 1A and 1B are diagrams illustrating a difference between an. encoding scheme which generates a differential image and an encoding scheme in the present embodiment. FIG. 1A exemplarily shows the differential image between the previous frame and the current frame and FIG. 1B exemplarily shows reference positions which are referred to when prediction data is generated in the present embodiment.

As exemplarily shown in FIG. 1A, the differential image between the previous frame (the base image) and the current frame is constructed with a differential value which is calculated by comparing pixels belonging to the respective frames to each other with respect to all pixels. For this reason, in a static portion, the differential value has 0, but, in a motion portion, the differential value exists and has various values. Specifically, the differential image has a different pixel value in at least the static portion and the motion portion. For this reason, an inconsecutive pixel value occurs in the differential image, which results in degrading the compression rate.

On the other hand, as exemplarily shown in FIG. 1B, the image processing device in the present embodiment refers to reference pixels A to D which are present on the same image as a pixel of notice X and a reference pixel E which is present on another image (a reference image). Then, the present image processing device selects one of the reference pixels (A to E) which has a constant relation to the pixel of notice X and generates prediction data based on a pixel value of the selected reference pixel. Specifically, the present image processing device applies the pixel value of another image only when it has an advantage in terms of the compression rate, without uniformly applying the pixel value of another image (the previous frame), thereby realizing the high compression rate.

[First Embodiment]

Next, a hardware configuration of an image processing device 2 in the first embodiment will be described.

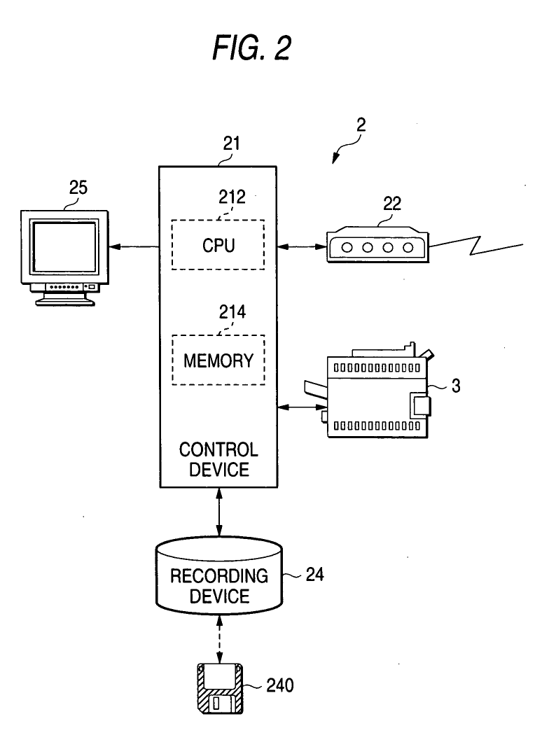

FIG. 2 is a diagram exemplarily showing the hardware configuration of the image processing device 2 to which an encoding method and a decoding method according to the present invention is applied, with laying emphasis on a control device 21.

As exemplarily shown in FIG. 2, the image processing device 2 has the control device 21 having a CPU 212, a memory 214, and so on, a communication device 22, a recording device 24 such as a HDD or CD device, and a user interface device (a UI device) 25 having an LCD display device or a CRT display device, a keyboard or a touch panel, and so on.

For example, the image processing device 2 is a general computer in which an encoding program 5 (described later) and a decoding program 6 according to the present invention (described later) are installed as a part of a printer driver. The image processing device 2 acquires image data via the communication device 22, the recording device 24, or the like, encodes or decodes acquired image data, and transmits encoded or decoded data to a printer device 3.

[Encoding Program]

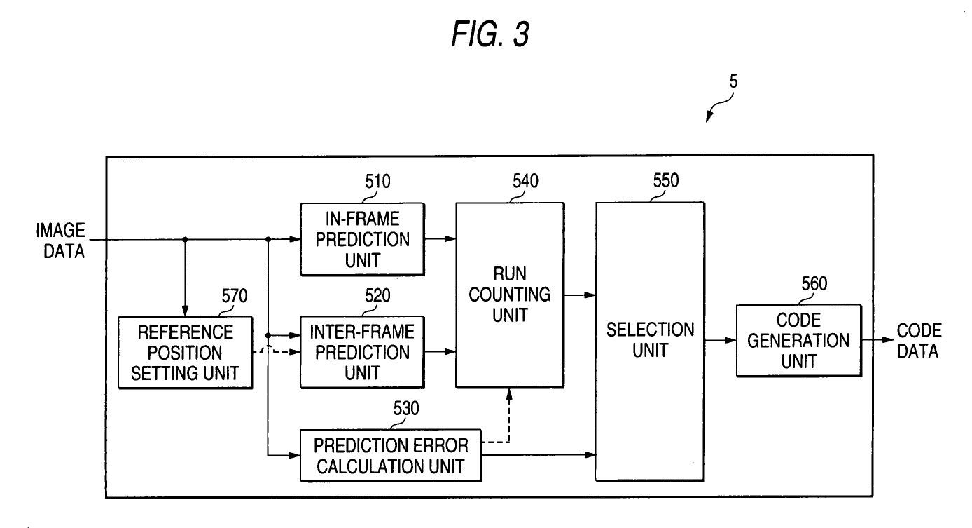

FIG. 3 is a diagram exemplarily showing a functional configuration of the first encoding program 5 which is executed by the control device 21 (see FIG. 2) and realizes an encoding method according to the present invention.

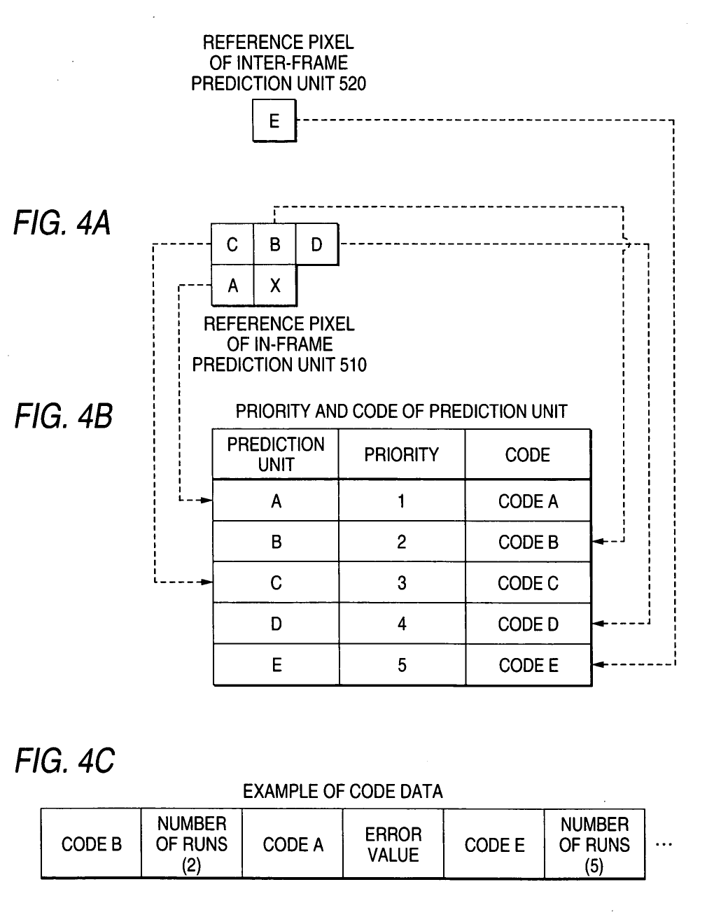

FIGS. 4A and 4B are diagrams illustrating an encoding process which is made by the encoding program 5. FIG. 4A exemplarily shows positions of pixels which are referred to by means of an in-frame prediction unit 510 and an inter-frame prediction unit 520, FIG. 4B exemplarily shows codes associated with the respective reference pixels, and FIG. 4C exemplarily shows code data which is generated by the encoding program 5.

As exemplarily shown in FIG. 3, the first encoding program 5 has the in-frame prediction unit 510, the inter-frame prediction unit 520, a prediction error calculation unit 530, a run counting unit 540, a selection unit 550, a code generation unit 560, and a reference position setting unit 570. Moreover, a combination of the in-frame prediction unit 510, the inter-frame prediction unit 520, the prediction error calculation unit 530, the run counting unit 540, and the selection unit 550 is an example of a reference information generating unit according to the present invention.

In the encoding program 5, image data is input via the communication device 22, the recording device 24, or the like. Input image data is rasterized in a previous stage of the encoding program 5.

The in-frame prediction unit 510 refers to a pixel value of each of plural reference positions different from each other on a frame image to be encoded (hereinafter, referred to as an object frame), set the pixel value to a prediction value, and outputs the comparison result of the prediction value and the pixel value of the pixel of notice to the run counting unit 540. As shown in FIG. 4A, the in-frame prediction unit 510 of this embodiment compares the pixel value of each of the reference pixels A to D on the object frame to the pixel value of the pixel of notice X to be encoded and, when the pixel value of one of the reference pixels A to D matches with the pixel value of the pixel of notice X (that is, when the prediction hits), outputs a prediction unit ID (described later) to identify the reference position to the run counting unit 540. However, when the pixel value of any one of the reference pixels A to D does not match with the pixel value of the pixel of notice X, the in-frame prediction unit 510 outputs a purport that they do not match with each other to the run counting unit 540. As shown in FIG. 4A, the position of each of the reference pixels A to D is set to a relative position with respect to the pixel of notice X. Specifically, the reference pixel A is set on an upstream in a main scanning direction of the pixel of notice X, and each of the reference pixels B to D is set on a main scanning line above the pixel of notice X (an upstream in a sub scanning direction).

Moreover, the in-frame prediction unit 510 may predict by referring to at least one reference pixel. For example, the in-frame prediction unit 510 may refer to only the reference pixel A, compare the pixel value of the reference pixel A to the pixel value of the pixel of notice X, and output the comparison result to the run counting unit 540.

The inter-frame prediction unit 520 refers to a pixel value of another frame image (hereinafter, referred to as a reference frame) different from the object frame, sets the pixel value of the reference frame to a prediction value, outputs the comparison result of the prediction value and the pixel value of the pixel of notice (the pixel included in the object frame) to the run counting unit 540. As shown in FIG. 4A, the inter-frame prediction unit 520 of this embodiment compares the pixel value of the reference pixel E included in the reference frame to the pixel value of the pixel of notice X and, when the pixel values match with each other (that is, when the prediction hits), outputs the prediction unit ID (described later) to identify the reference position to the run counting unit 540. In other cases, the inter-frame prediction unit 520 outputs a purport that they do not matches each other to the run counting unit 540. The relative position of the reference pixel E as a basis corresponds to the relative position of the pixel of notice X in the object frame. For example, when resolution of the object frame and resolution of the reference frame match with each other, the relative position of the reference pixel E and the relative position of the pixel of notice X are the same. That is, when the object frame overlaps the reference frame, the reference pixel E overlaps the pixel of notice X.

Hereinafter, a prediction process which is made by referring to within the object frame (that is, a prediction process which is made by means of the in-frame prediction unit 510) is referred to as an in-frame prediction. Further, a prediction process which is made by referring to the reference frame (that is, a prediction process which is made by means of the inter-frame prediction unit 520) is referred to as an inter-frame prediction.

The prediction error calculation unit 530 predicts the pixel value of the pixel of notice with a previously given prediction method, subtracts the prediction value from an actual pixel value of the pixel of notice, and outputs the subtraction result to the run counting unit 540 and the selection unit 550 as a prediction error value. The prediction method of the prediction error calculation unit 530 may correspond to a prediction method of the decoding program (described later) which decodes code data. In this embodiment, the prediction error calculation unit 530 sets the pixel value of the same reference position (the reference pixel A) as that of the in-frame prediction unit 510 to a prediction value and calculates a difference between the prediction value and the actual pixel value (the pixel value of the pixel of notice X)

The run counting unit 540 counts the consecutive number of the same prediction unit ID and outputs the prediction unit ID and the consecutive number to the selection unit 550. The prediction unit ID and the consecutive number are examples of reference information to the object frame and the reference frame. For example, when the prediction error value is input, the run counting unit 540 outputs the prediction unit ID and the consecutive number which are counted with an internal counter, and then outputs the input prediction error value to the selection unit 550 as it is.

In this embodiment, as shown in FIG. 4B, a priority is set to the respective reference pixels A to E. When the prediction hits with the plural reference pixels, the run counting unit 540 (FIG. 3) increases the consecutive number of the prediction unit ID according to the set priority. Moreover, the priority of the plural the reference pixels A to E may be set according to a hitting ratio of the prediction value (a probability that the pixel value of the reference pixel and the pixel value of the pixel of notice X matches with each other) and it may be dynamically changed by means of an MRU (Most Recently Used) algorithm.

The selection unit 550 selects the prediction unit ID being consecutive to the longest based on the prediction unit ID, the consecutive number, and the prediction error value input from the run counting unit 540 and outputs the prediction unit ID, the consecutive number, and the prediction error value to the code generation unit 560 as prediction data.

The code generation unit 560 encodes the prediction unit ID, the consecutive number, and the prediction error value input from the selection unit 550 and outputs them to the communication device 22, the recording device 24, or the like.

More specifically, as shown in FIG. 4B, the code generation unit 560 associates the prediction unit ID (the reference position) with a code and outputs a code corresponding to the reference position which has the pixel value matching with that of the pixel of notice X. Moreover, the code associated with each of the reference positions is, for example, an entropy code which is set according to the hitting ratio of each of the reference positions and has a code length corresponding to the priority.

Further, when the pixel value at the same reference position consecutively matches with the pixel value of the pixel of notice X, the code generation unit 560 encodes the consecutive number which is counted by means of the run counting unit 540. Accordingly, the code amount decreases. As such, as exemplarily shown in FIG. 4C, when the pixel value at one of the reference positions matches with the pixel value of the pixel of notice X, the encoding program 5 encodes the code corresponding to the reference position and the consecutive number that the pixel value at the reference position matches with the pixel value of the pixel of notice X. On the other hand, when the pixel values at any reference positions do not match with the pixel value of the pixel of notice X, the encoding program 5 encodes the difference (the prediction error value) between the pixel value of the predefined reference position and the pixel value of the pixel of notice X.

The reference position setting unit 570 sets the position of each of the reference pixels and the number of the reference pixels which are referred to by means of the inter-frame prediction unit 520, according to the object frame. For example, the reference position setting unit 570 compares the object frame to the reference frame and changes the number of the reference positions referred to in the inter-frame prediction or the relative position (a position with respect to the entire reference frame) according to the difference between the image included in the object frame and the image included in the reference frame (for example, a movement direction of an object or the like). The inter-frame prediction unit 520 sets the pixel value of the reference pixel set by the reference position setting unit 570 to a prediction value.

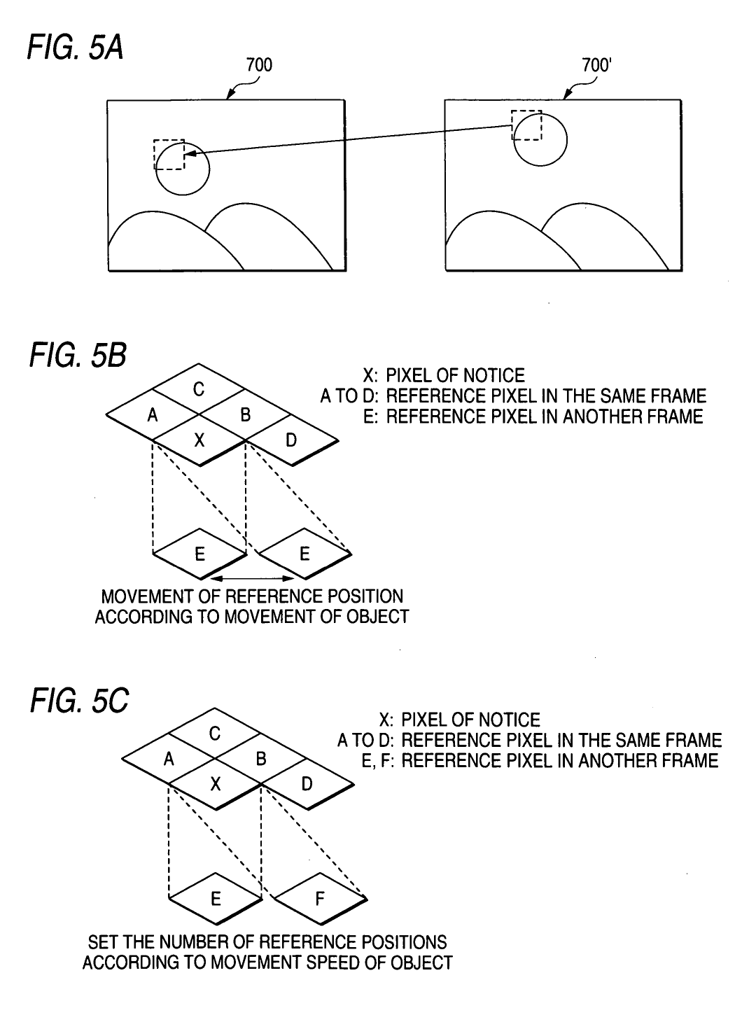

FIGS. 5A to 5C are diagram illustrating the reference position which is set according to the movement of the object.

As exemplarily shown in FIG. 5A, when the object in the motion picture (in this embodiment, ‘the moon’) moves, the position of the object changes between the plural frames constituting the scene. As in this embodiment, when the object (the moon) included in a current frame 700′ (the object frame) is encoded, the reference position is set so that the same object (the moon) included in a previous frame 700 (the reference frame) is referred to. Accordingly, the prediction hitting ratio increases, thereby enhancing the compression rate.

Therefore, when encoding a moving object (that is, a different area between the previous frame 700 and the current frame 700′), the reference position setting unit 570 of this embodiment changes the reference position to which the inter-frame prediction unit 520 refers, as exemplarily shown in FIG. 5B. More specifically, the reference position setting unit 570 changes the reference position, which is referred to by the inter-frame prediction, according to the movement direction and the movement amount of the object.

Further, as a case in which the movement speed of the object is high or the number of the moving objects is large, when the differential amount between the previous frame 700 and the current frame 700′ is large, the hitting ratio in the inter-frame prediction may be lowered.

Therefore, as exemplarily shown in FIG. 5C, the reference position setting unit 570 of this embodiment changes the number of the reference positions, to which the inter-frame prediction unit 520 refers, according to the differential amount between the previous frame 700 and the current frame 700′. More specifically, the reference position setting unit 570 increase the number of the reference positions being referred to in the inter-frame prediction as the differential amount between the previous frame 700 and the current frame 700′ is large (for example, in the case in which the movement speed of the object is high, as the number of the moving objects is large).

As such, the reference position setting unit 570 sets the reference position, to which the inter-frame prediction unit 520 refers, according to the movement direction of the object or the like. Accordingly, the prediction hitting ratio increases, thereby enhancing the compression rate.

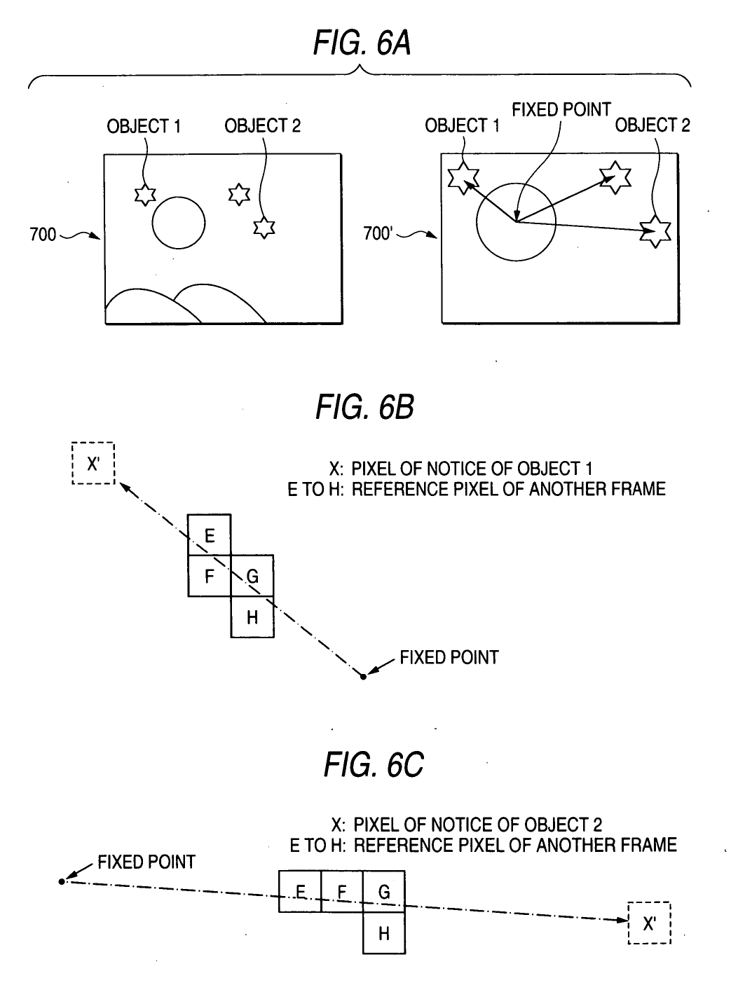

FIGS. 6A to 6C are diagrams illustrating reference positions which are set on a zoomed scene. Moreover, in FIGS. 6A to 6C, a pixel on the reference frame (the previous frame) corresponding to the pixel of notice X on the object frame (the current frame) is referred to as a ‘pixel of notice X′’.

As exemplarily shown in FIG. 6A, in a scene (a zoomed scene) in which the size of the object changes by means of zooming-in or zooming-out, a point (a fixed point) which does not displace between the previous frame 700 (the reference frame) and the current frame 700′ (the object frame) exits. In this embodiment, by expansion with the fixed point as a center, the respective objects on the previous frame 700 are magnified on the current frame 700′. In this case, the size of each of the objects changes and simultaneously the position of each of the objects radially moves with the fixed point as the center.

Therefore, when encoding the frame of the zoomed scene, the reference position setting unit 570 of this embodiment sets the reference position (the reference position to which the inter-frame prediction unit 520 refers) according to the zoomed amount (magnification, de-magnification, or the like) with the fixed point as a basis. For example, in a scene in which zooming-in is made, the reference position setting unit 570 sets the reference position, to which the inter-frame prediction unit 520 refers, in a vicinity of an internally dividing point between a position corresponding to the pixel of notice X on the previous frame 700 (the reference frame) and the fixed point. Therefore, when the pixel of notice X is disposed at a left side from the fixed point (the upstream of the main scanning direction), as exemplarily shown in FIG. 6B, the reference position which is referred to in the inter-frame prediction is set at a right side of the pixel of notice X′ (a downstream of the main scanning direction). Further, when the pixel of notice X is disposed at a right side from the fixed point (the downstream of the main scanning direction), as exemplarily shown in FIG. 6C, the reference position is set at a right side of the pixel of notice X′ (the upstream of the main scanning direction). Further, when the pixel of notice X is disposed above the fixed point (the upstream of the sub scanning direction), as exemplarily FIG. 6B, the reference position which is referred to in the inter-frame prediction is set below the pixel of notice X′ (a downstream of the sub scanning direction). Further, when the pixel of notice X is disposed below the fixed point (the downstream of the sub scanning direction), as exemplarily shown in FIG. 6C, the reference position is set above the pixel of notice X′ (the upstream of the sub scanning direction).

Further, in a scene in which zooming-out is made, the reference position setting unit 570 sets the reference position, to which the inter-frame prediction unit 520 refers, in a vicinity of an externally dividing point between the position (the pixel of notice X′) corresponding to the pixel of notice X on the previous frame 700 (the reference frame) and the fixed point. For example, when the pixel of notice X is disposed at the left side from the fixed point (the upstream of the main scanning direction), the reference position which is referred to in the inter-frame prediction is set at the left side of the pixel of notice X′ (the upstream of the main scanning direction). Further, when the pixel of notice X is disposed at the right side from the fixed point (the downstream of the main scanning direction), the reference position is set at the right side of the pixel of notice X′ (the downstream of the main scanning direction). Further, when the pixel of notice X is disposed above the fixed point (the upstream of the sub scanning direction), the reference position which is referred to in the inter-frame prediction is set above the pixel of notice X′ (the upstream of the sub scanning direction). Further, when the pixel of notice X is disposed below the fixed point (the downstream of the sub scanning direction), the reference position is set below the pixel of notice X′ (the downstream of the sub scanning direction).

As such, the reference position setting unit 570 sets the reference position, to which the inter-frame prediction unit 520 refers, according to the fixed point and the zoomed amount on the zoomed scene. Accordingly, the prediction hitting ratio increases, thereby enhancing the compression rate.

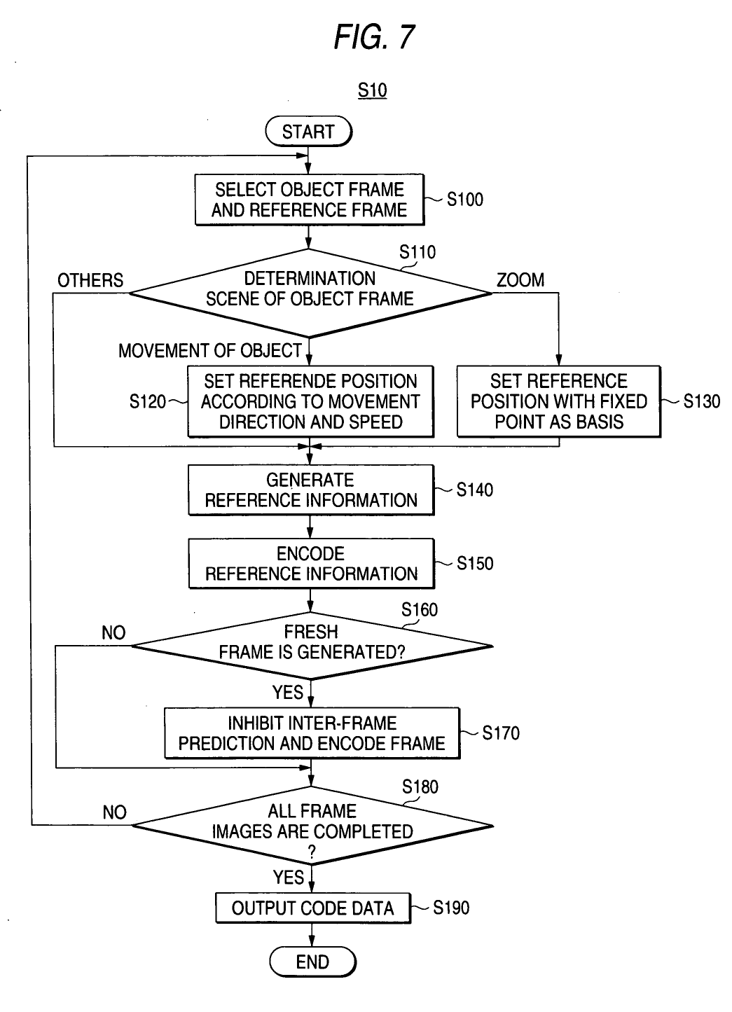

FIG. 7 is a flowchart illustrating an operation of an encoding process (S10) by means of the encoding program 5.

As shown in FIG. 7, in a step 100 (S100), when image data (the plural frames) of the motion picture is input, the encoding program 5 sequentially selects the object frame and the reference frame among the input frames. The encoding program 5 of this embodiment selects the object frame in an order that the motion picture is reproduced and selects a frame just before the selected object frame as the reference frame.

In a step 110 (S110), the reference position setting unit 570 compares the object frame to the reference frame and determines a scene based on the difference between these frames. If it is determined that the scene is one in which the object is moving, the reference position setting unit 570 progresses the process to a step 120 (S120). If it is determined that the scene is the zoomed scene, the reference position setting unit 570 progresses the process to a step 130 (S130). In other cases, the reference position setting unit 570 sets the reference position of the object (the reference position used in the inter-frame prediction) and progresses the process to a step 140 (S140).

In the step 120 (S120), as described with reference to FIG. 5, the reference position setting unit 570 sets the reference position, which is used in the inter-frame prediction, according to the movement direction and the movement amount of the object.

In the step 130 (S130), as described with reference to FIG. 6, the reference position setting unit 570 sets the reference position, which is used in the inter-frame prediction, according to the zoomed amount and the fixed point.

In the step 140 (S140), the encoding program 5 generates reference information with respect to each of the pixels of notice included in the object frame. More specifically, the in-frame prediction unit 510 compares the pixel value of each of the pixels of notice X (FIG. 4) on the object frame to the pixel value of each of the reference pixels A to D (FIG. 4) on the object frame and outputs the comparison result (the prediction unit ID) to the run counting unit 540. The inter-frame prediction unit 520 compares the pixel value of the reference pixel E (FIG. 4) on the reference frame set by the reference position setting unit 570 to the pixel value of the pixel of notice X and outputs the comparison result (the prediction unit ID) to the run counting unit 540. Further, the prediction error calculation unit 530 calculates the prediction error with respect to each of the pixels of notice X and outputs it to the run counting unit 540 and the selection unit 550.

The run counting unit 540 counts the consecutive number of the same prediction unit ID based on the comparison results (the prediction unit ID) input from the in-frame prediction unit 510 and the inter-frame prediction unit 520 and outputs the prediction unit ID and the consecutive number of the prediction unit ID to the selection unit 550.

The selection unit 550 selects the prediction unit ID being consecutive to the longest based on the prediction unit ID, the consecutive number, and the prediction error value input from the run counting unit 540 and outputs the prediction unit ID, the consecutive number, and the prediction error value to the code generation unit 560 as reference information.

In a step 150 (S150), the code generation unit 560 encodes reference information (the prediction unit ID, the consecutive number, and the prediction error value) input from the selection unit 550.

In a step 160 (S160), the encoding program 5 determines whether or not it is the timing that a refresh frame is generated. Here, the refresh frame means a frame which is encoded without referring to another frame (the reference frame). When the encoding process is performed with the inter-frame prediction by the predefined number of the frames after the generation of the refresh frame, the encoding program 5 of this embodiment determines that it is the timing for the generation of the refresh frame and thus progresses the process to a step 170 (S170). In other cases, the encoding program 5 progresses the process to a step 180 (S180). That is, the encoding program 5 of this embodiment generates the refresh frame at a predefined interval (for every predefined number of frames).

In the step 170 (S170), the encoding program 5 encodes a next object frame without applying the prediction process by means of the inter-frame prediction unit 520. That is, the encoding program 5 of this embodiment encodes the object frame by means of a predictive encoding process which refers to only the reference pixel within the same frame. Moreover, the encoding process which is applied to the refresh frame is not limited to the predictive encoding process. For example, JPEG or the like may be used.

In the step 180 (S180), the encoding program 5 determines whether or not all the frames constituting the motion picture are encoded. If it is determined that all the frames are encoded, the process progresses to a step 190 (S190). In other cases, the process returns to the step 100 (S100) to select the next object frame and the reference frame corresponding thereto and repeats the process from the step 110 (S110) to the step 180 (S180).

In the step 190 (S190), the encoding program 5 outputs code data of all the frames constituting the motion picture to the recording device 24 (FIG. 2) or the like.

As described above, when encoding the object frame, the encoding program 5 performs the predictive encoding with reference to another frame (the reference frame). Accordingly, image data of the pixel of notice on the object frame is encoded with the correlation with pixels on another frame, in addition to the correlation with neighboring pixels on the same frame. Therefore, the prediction hitting ratio increases, and thus the compression rate is enhanced.

[Decoding Program]

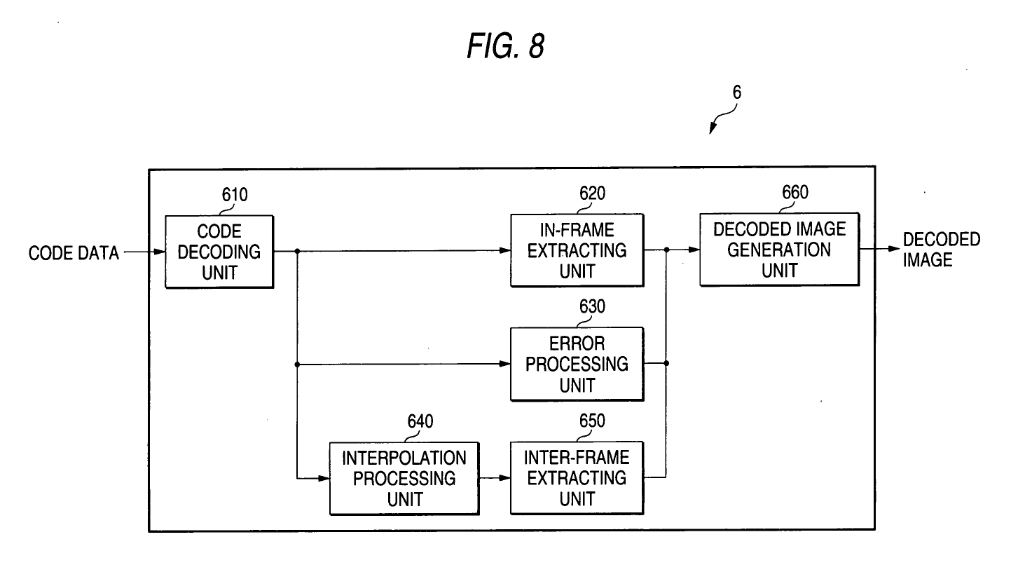

FIG. 8 is a diagram exemplarily showing a functional configuration of a decoding program 6 which is executed by the control device 21 (FIG. 2) and implements a decoding method according to the present invention.

As exemplarily shown in FIG. 8, the decoding program 6 has a code decoding unit 610, an in-frame extracting unit 620, an error processing unit 630, an interpolation processing unit 640, an inter-frame extracting unit 650, and a decoded image generation unit 660.

In the decoding program 6, as exemplarily shown in FIG. 4B, the code decoding unit 610 has a table associating the codes with the prediction unit IDs (reference positions) and specifies the reference position (the prediction unit ID) based on input code data. Further, the code decoding unit 610 also decodes numeric values such as the consecutive number of the prediction unit IDs or the prediction error based on input code data.

The reference position, the consecutive number, and the prediction error (that is, reference information) decoded in such a manner are input to the in-frame extracting unit 620, the error processing unit 630, and the interpolation processing unit 640.

When the prediction unit ID input from the code decoding unit 610 corresponds to any one of the in-frame prediction (that is, when it corresponds to one of the reference pixels A to D), the in-frame extracting unit 620 refers to a pixel of the corresponding reference position and outputs the pixel value of the pixel to the decoded image generation unit 660 as decoded data. Further, when the consecutive number is input together with the prediction unit ID, the in-frame extracting unit 620 associates the prediction unit ID with the corresponding pixel value and outputs the consecutive number to the decoded image generation unit 660.

If the prediction error is input from the code decoding unit 610, the error processing unit 630 outputs the pixel value corresponding to the input prediction error to the decoded image generation unit 660 as decoded data. The error processing unit 630 of this embodiment adds the input prediction error and the pixel value of a left next pixel (the position corresponding to the reference position A) to generate decoded data.

When the prediction unit ID input from the code decoding unit 610 corresponds to any one of the inter-frame prediction, the interpolation processing unit 640 compares the resolution of the referred reference frame to the resolution of the object frame. When the resolutions are difference from each other, the interpolation processing unit 640 performs an interpolation process.

For example, the interpolation processing unit 640 performs the interpolation process such as a nearest neighboring method, a linear interpolation method or a cubic convolution method on the reference frame and accords the resolution of the reference frame to the resolution of the object frame.

When the prediction unit ID and the consecutive number corresponding to the inter-frame prediction is input from the code decoding unit 610, the inter-frame extracting unit 650 extracts the pixel value of the pixel with reference to the pixel of the reference frame and outputs the extracted pixel value and the input consecutive number to the decoded image generation unit 660. Further, when the interpolation process is performed on the reference frame, the inter-frame extracting unit 650 extracts the pixel value after the interpolation process from the reference frame.

The decoded image generation unit 660 generates a decoded image based on decoded data input from the in-frame extracting unit 620, decoded data input from the error processing unit 630, and decoded data input from the inter-frame extracting unit 650. More specifically, when decoded data (the pixel value and the consecutive number) is input from the in-frame extracting unit 620, the decoded image generation unit 660 consecutively arranges the pixels having the input pixel value by the consecutive number. Further, when decoded data (the sum of the prediction error and the left next pixel value) is input from the error processing unit 630, the decoded image generation unit 660 arranges the pixels having the sum as the pixel value. Further, when decoded data (the pixel value and the consecutive number) is input from the inter-frame extracting unit 650, the decoded image generation unit 660 consecutively arranges the pixels having the input pixel value by the consecutive number. A group of pixels arranged in such a manner constitutes the decoded image.

As such, the decoding program 6 of this embodiment refers to the object frame or the reference frame according to input code data and generates the decoded image with the pixel value of the referred pixel.

As described above, the image processing device 2 according to the present embodiment refers to another frame (the reference frame) different from the object frame to be encoded and performs the predictive encoding process. Thus, image data of each of the frames constituting the motion picture is efficiently encoded. Further, by referring to the object frame or the reference frame, code data encoded in such a manner can be decoded.

[First Modification]

Next, a modification of the above-described first embodiment will be described. The image processing device 2 of the above-described embodiment reciprocally encodes image data of each of the frames constituting the motion picture. To the contrary, an image processing device 2 of the present modification non-reciprocally encodes image data of each of the frames, thereby enhancing the compression rate.

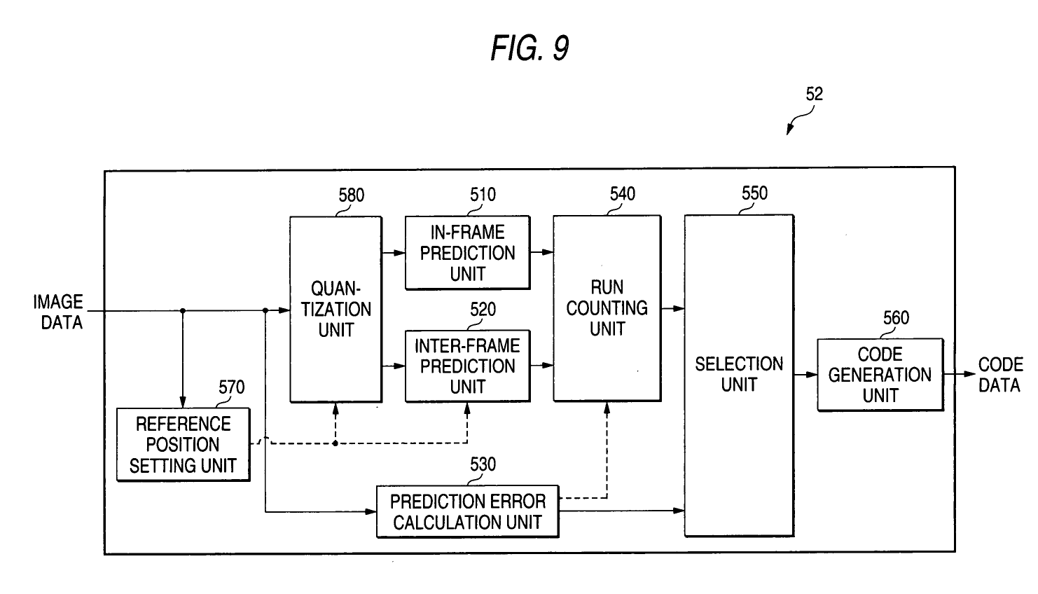

FIG. 9 is a diagram exemplarily showing a functional configuration of a second encoding program 52. Moreover, in FIG. 9, the substantially same elements as those shown in FIG. 3 are represented by the same reference numerals.

As exemplarily shown in FIG. 9, the second encoding program 52 has a configuration in which a quantization unit 580 is added to the first encoding program 5.

In the present modification, when the difference between the pixel value of the pixel of notice and the pixel value of the reference pixel falls within a tolerance, the quantization unit 580 degenerates the pixel values to a single pixel value. More specifically, when the difference between the pixel value of the pixel of notice and the pixel value of each of the reference pixels which are referred to in the in-frame prediction falls within a predefined tolerance, the quantization unit 580 substitutes the pixel value of the pixel of notice with the pixel value of the reference pixel and outputs image data suffered from the substitution of the pixel value to the in-frame prediction unit 510. As such, the hitting ratio of the in-frame prediction by means of the in-frame prediction unit 510 is enhanced. Further, when the difference between the pixel value of the pixel of notice and the pixel value of the reference pixel which is referred to in the inter-frame prediction falls within a predefined tolerance, the quantization unit 580 substitutes the pixel value of the pixel of notice with the pixel value of the reference pixel and outputs image data suffered from the substitution of the pixel value to the inter-frame prediction unit 520. Thus, the hitting ratio of the inter-frame prediction by means of the inter-frame prediction unit 520 is enhanced.

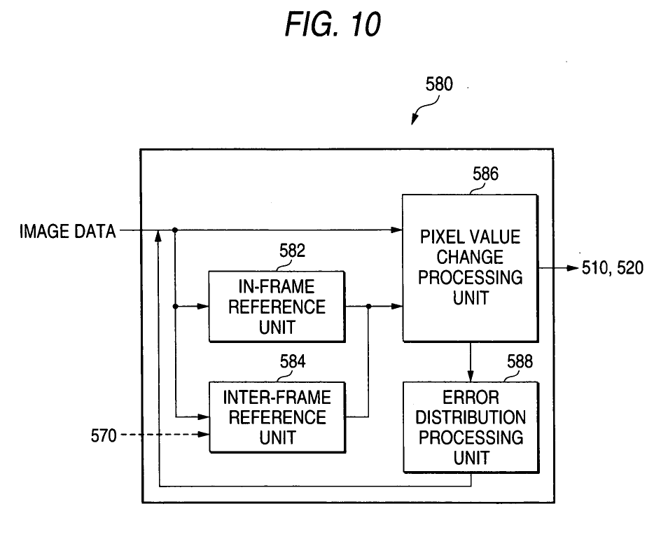

FIG. 10 is a diagram exemplarily showing a functional configuration of the quantization unit 580.

As exemplarily shown in FIG. 10, the quantization unit 580 has an in-frame reference unit 582, an inter-frame reference unit 584, a pixel value change processing unit 586, and an error distribution processing unit 588.

In the quantization unit 580, the in-frame reference unit 582 refers to the pixel of the reference position (that is, the reference position within the object frame), which is referred to by means of the in-frame prediction unit 510, to output the pixel value of the pixel to the pixel value change processing unit 586.

The inter-frame reference unit 584 refers to the pixel of the reference position (that is, the reference position within the reference frame), which is referred to by means of the inter-frame prediction unit 520, to output the pixel value of the pixel to the pixel value change processing unit 586.

The pixel value change processing unit 586 compares the pixel value of the pixel of notice to the pixel value input from the in-frame reference unit 582 or the pixel value input from the inter-frame reference unit 584 and, when the difference is equal to or less than a previously set tolerable differential value (that is, when the difference falls within a tolerance), outputs the pixel value input from the in-frame reference unit 582 or the inter-frame reference unit 584 to the in-frame prediction unit 510 (FIG. 9) or the inter-frame prediction unit 520 (FIG. 9) as the pixel value of the pixel of notice, and outputs the difference (hereinafter, referred to as a differential value) between the pixel value of the pixel of notice and the pixel value input from the in-frame reference unit 582 or the inter-frame reference unit 584 to the error distribution processing unit 588. On the other hand, when the difference between the pixel value of the pixel of notice and the pixel value input from the in-frame reference unit 582 or the inter-frame reference unit 584 is larger than the tolerable differential value (that is, when the difference does not fall within the tolerance), the pixel value change processing unit 586 outputs the pixel value of the pixel of notice to the in-frame prediction unit 510 (FIG. 9) or the inter-frame prediction unit 520 (FIG. 9) as it is and also outputs 0 (zero) to the error distribution processing unit 588.

Moreover, when the pixel value of the pixel of notice is consecutively substituted with the pixel value of one reference position, the tolerable differential value (the tolerance) preferably decreases (narrow) according to the consecutive number.

Further, the pixel value change processing unit 586 sets the tolerable differential value with respect to the difference between the pixel value of the pixel of notice and the pixel value input from the inter-frame reference unit 584 to be larger than the tolerable differential value with respect to the difference between the pixel value of the pixel of notice and the pixel value input from the in-frame reference unit 582. That is, the quantization unit 580 of the present embodiment permits more non-reciprocity in the inter-frame prediction than in the in-frame prediction. In general, non-reciprocity in the inter-frame prediction (the change of the pixel value) is difficult to be actualized because of deterioration in image quality, but flickering in the motion picture can be suppressed. Moreover, the pixel value change processing unit 586 may set the tolerable differential value with respect to the difference between the pixel value of the pixel of notice and the pixel value input from the inter-frame reference unit 584 to a fixed value and set the tolerable differential value with respect to the difference between the pixel value of the pixel of notice and the pixel value input from the in-frame reference unit 582 to a variable value which decreases according to the consecutive number.

The error distribution processing unit 588 generates an error distribution value based on an error value input from the pixel value change processing unit 586 and adds it to the pixel value of a predetermined pixel included in image data. For example, when either the pixel value input from the in-frame reference unit 582 or the pixel value input form the inter-frame reference unit 584 does not satisfy the tolerance (that is, when 0 (zero) is input from the pixel value change processing unit 586), the error distribution processing unit 588 calculates the error distribution value based on the accumulated error value and distributes the calculated error distribution value. The error distribution value is calculated by multiplying the error value by a value of a weighted matrix according to, for example, an error diffusion method or a minimized average error method which uses the weighted matrix. As such, the error value is distributed to the neighboring pixels, and thus a mean pixel value of partial pixels is maintained uniformly.

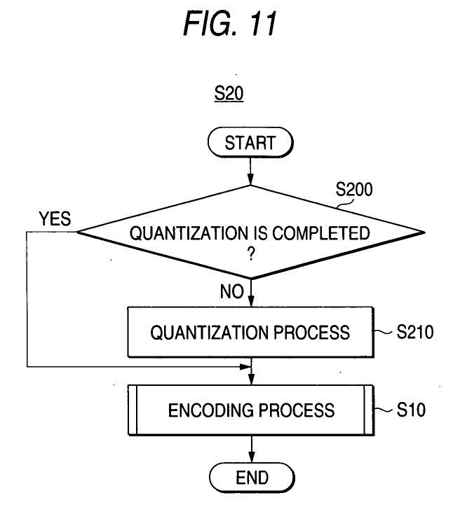

FIG. 11 is a flowchart illustrating the operation of the encoding process (S20) by the second encoding program 52.

As shown in FIG. 11, in a step 200 (S200), when image data of the motion picture (plural frames) is input, the encoding program 52 determines whether or not the quantization process is performed on input image data of the motion picture. For example, the encoding program 52 determines whether or not the encoding process by the encoding program 52 is performed, based on data appended to input image data of the motion picture. If it is determined that the encoding process by the encoding program 52 is performed (that is, when the quantization process by the quantization unit 580 is executed), the process progresses to the step S10. When the encoding process by the encoding program 52 is not performed (that is, when the quantization process by the quantization unit 580 is not executed), the process progresses to a step 210 (S210).

That is, the encoding program 52 of the present embodiment causes the quantization process 580 to execute the quantization process on data of the same motion picture just once. Accordingly, a non-reciprocal encoding is repetitively performed, such that the image quality can be prevented from deteriorating (generation noise).

In the step 210 (S210), the quantization unit 580 (FIG. 9) executes the quantization process corresponding to the in-frame prediction (the prediction process performed by the in-frame prediction unit 510) or the inter-frame prediction (the prediction process performed by the inter-frame prediction unit 520) on image data (plural frames) of the input motion picture.

The quantization unit 580 appends data, which indicates that the quantization process is performed, to data of the motion picture suffered from the quantization process and outputs it to the in-frame prediction unit 510 and the inter-frame prediction unit 520.

In the step 10 (S10), the encoding program 52 encodes the respective frames constituting the motion picture in a sequence described with reference to FIG. 7. That is, the encoding program 52 sequentially selects the object frame and the reference frame among the input frames. The in-frame prediction unit 510 compares the pixel value of the pixel of notice X (FIG. 4) suffered from the quantization process to the pixel value of each of the reference pixels A to D (FIG. 4) on the object frame and outputs the comparison result to the run counting unit 540. Then, the inter-frame prediction unit 520 compares the pixel value of the reference pixel E (FIG. 4) on the reference frame set by the reference position setting unit 570 to the pixel value of the pixel of notice X suffered from the quantization process and outputs the comparison result to the run counting unit 540. Further, the prediction error calculation unit 530 calculates the prediction error to each pixel of notice X and output it to the run counting unit 540 and the selection unit 550.

The run counting unit 540 counts the consecutive number of the same prediction unit ID based on the comparison result input from the in-frame prediction unit 510 and the inter-frame prediction unit 520 and outputs the prediction unit ID and the consecutive number thereof to the selection unit 550. The selection unit 550 selects the prediction unit ID being consecutive to the longest based on the prediction unit ID, the consecutive number, and the prediction error value input from the run counting unit 540 and outputs the prediction unit ID, the consecutive number, and the prediction error value to the code generation unit 560 as reference information. The code generation unit 560 encodes reference information (the prediction unit ID, the consecutive number, and the prediction error value) input from the selection unit 550.

Further, if necessary, the encoding program 52 generates the refresh frame and, if all the frames are encoded, outputs code data of all the encoded frames to the recording device 24 (FIG. 2).

As such, the encoding program 52 according to the present modification fills the pixel of notice X with any one of the reference pixels A to E (approximate to the pixel value of the pixel of notice X). As such, the encoding program 52 can enhance the prediction hitting ratio by means of the in-frame prediction unit 510 or the inter-frame prediction unit 520, thereby enhancing the compression rate.

Moreover, when the difference between the pixel value of the pixel of notice and the pixel value of the reference pixel falls within the tolerance, the above-described quantization unit 580 substitutes the pixel value of the pixel of notice with the pixel value of the reference pixel. However, the present invention is not limited to this configuration. For example, when the differences between the pixel value of the pixel of notice and the pixel values of the reference pixels consecutively fall within the tolerance, the pixel value of the pixel of notice may be substituted with the statistical value (a mean pixel value, a modal value, a median value, or the like) of the pixel values of the reference pixels.

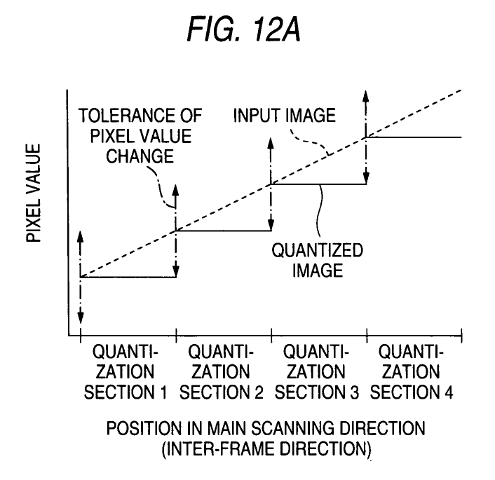

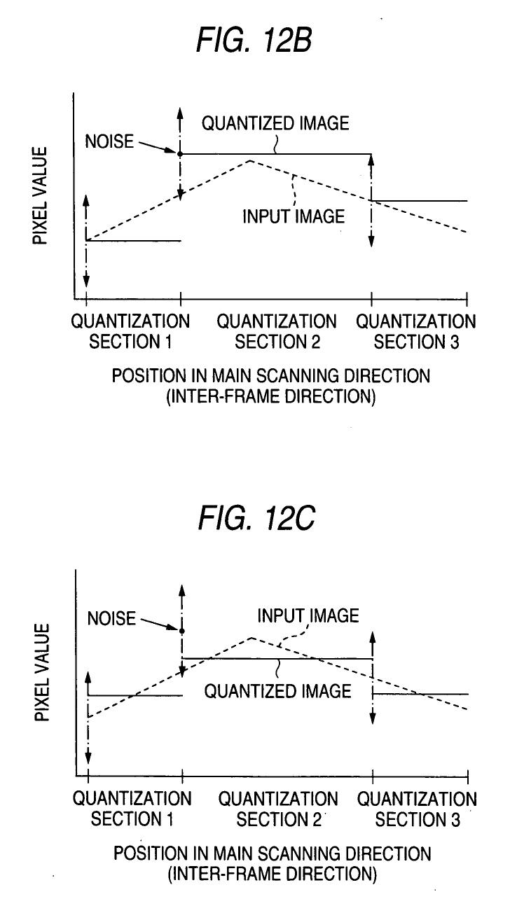

FIGS. 12A to 12C are diagrams exemplarily showing quantized image data (a quantized image). FIG. 12A exemplarily shows a case in which an ideal input image is quantized with a pixel value of a preceding pixel, FIG. 12B exemplarily shows a case in which an input image including noise is quantized with the pixel value of the preceding pixel, and FIG. 12C exemplarily shows a case in which the input image including noise is quantized with the mean pixel value of the group of pixels. Moreover, in FIGS. 12A to 12C, a dotted line represents the pixel value of the input image, a one-dot-chain line represents a range of the pixel value in which the quantization is permitted (a range corresponding to the tolerable differential value), and a solid line represents the pixel value after the quantization.

As exemplarily shown in FIG. 12A, the quantization by the reference pixel A (the reference position of a left next to the pixel of notice) is performed by setting the preceding pixel to a base pixel, by setting a succeeding group of pixels each having the pixel value falling within a predefined range (the one-dot-chain line) from the pixel value of the base pixel to a quantization section, and by substituting the group of pixels included in the quantization section with the pixel value of the base pixel. Then, when the pixel value of the succeeding pixel does not fall within the above-described range, a next quantization section is determined with the pixel as a next base pixel.

The input image (the dotted line) of this embodiment is an image the pixel value of which consecutively increase in the main scanning direction, and thus the quantized image (the solid line) becomes an image the pixel value of which increases in the main scanning direction in step wise. The quantized image is quantized with the pixel value of the preceding pixel (the reference pixel A), and thus it has the depth of color lower than that of the input image as a whole (that is, the pixel value becomes low). Similarly, in a case of the input image the pixel value of which decreases monotonically in the main scanning direction, the quantized image has the depth of color higher than that of the input image as a whole (that is, the pixel value becomes high). For this reason, it is necessary to distribute the error value by means of the error distribution processing unit 588 (FIG. 10), as described above.

Further, as exemplarily shown in FIG. 12B, when image data includes noise, the quantization section may be divided at the position of noise. In this case, if the quantization is performed with the pixel value of the preceding pixel, the group of pixels of the quantization section on a basis of the position of noise is substituted with the value of noise, and thus noise is diffused into the quantization section.

Therefore, the quantization unit 580 calculates the statistical value such as the mean value, the median value, or the modal vale with plural pixel values included in the quantization section and substitutes the pixel value of the quantization section with the statistical value.

For example, when the mean pixel value of the quantization section is quantized, as exemplarily shown in FIG. 12C, the pixel value of the quantized image has the same depth of color as the pixel value of the input image as a whole. Further, when the quantization is performed with the mean pixel value, influence by noise is mitigated.

Moreover, in FIGS. 12A to 12C, the quantization which is performed with the mean pixel value for the quantization section in the scanning direction (the quantization section in a spatial direction) in the same frame is described, but the present invention is not limited to this configuration. For example, for the quantization section in a time direction between the plural frames (that is, when the quantization is consecutively permitted with respect to the pixels disposed at the same relative position between the plural frames), the quantization unit 580 may be performed with the mean pixel value of the group of pixels which belong to the quantization section. Further, for the quantization section in the spatial and time directions (that is, when the pixel value of the group of pixels arranged in the scanning direction and the pixel value of the group of pixels disposed at the same relative position between the plural frames fall within the tolerance), the quantization may be performed with the mean pixel value of the group of pixels which belong to the quantization section in the spatial and time directions.

[Second Modification]

Next, a second modification of the above-described embodiment will be described. Each frame to be encoded may have a structure of plural layers. The encoding program 5 of the present modification encodes plural frames having the layer structure.

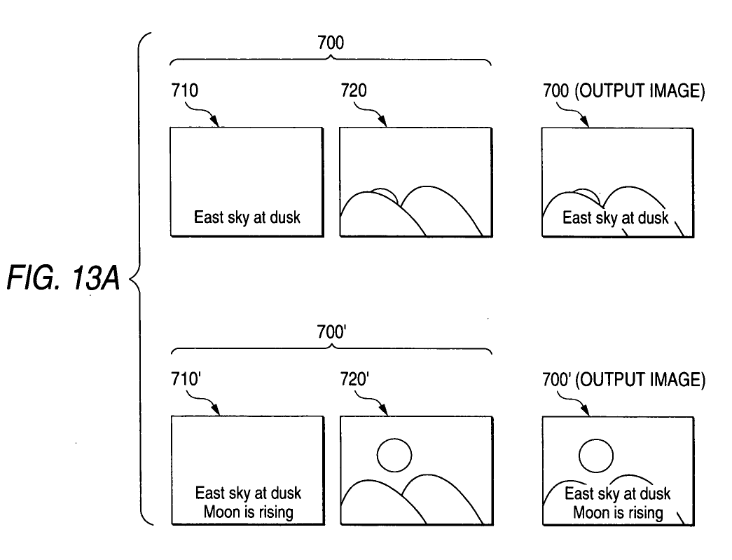

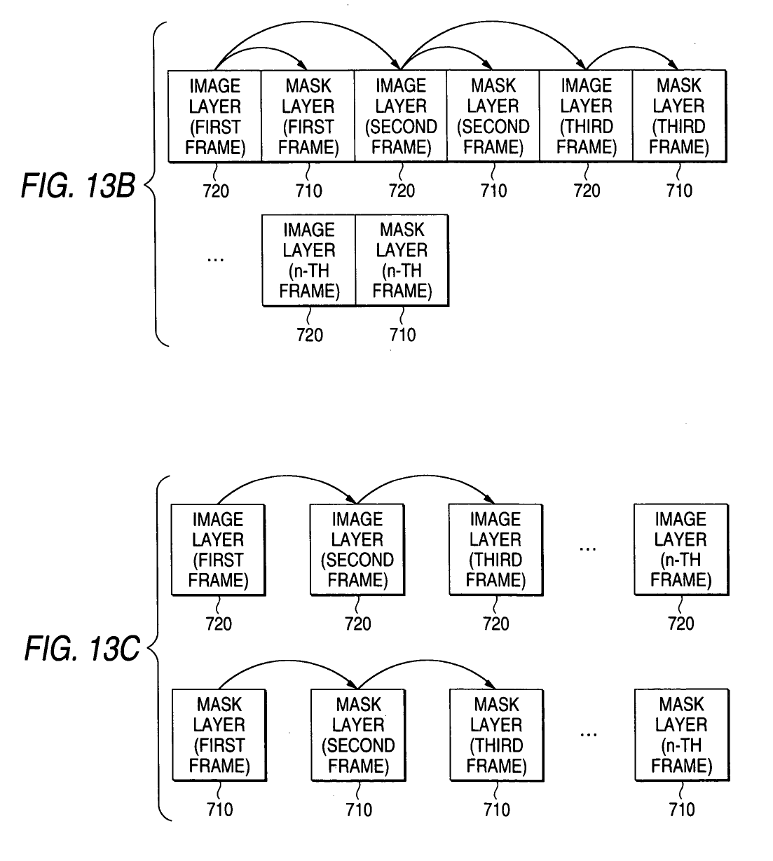

FIGS. 13A to 13C are diagrams illustrating an encoding method of a frame having the structure of plural layers. FIG. 13A exemplarily shows the frame having the layer structure, FIG. 13B illustrates an encoding method in which the plural frames having the layer structure are encoded in a single stream, and FIG. 13C illustrates an encoding method in which the plural frames having the layer structure are encoded in a multi-stream.

As exemplarily shown in FIG. 13A, the respective frames 700 constituting the motion picture have the plural layers (a mask layer 710 and an image layer 720) and are output in a state in which image elements allocated to the layers are synthesized. The image processing device 2 of this embodiment allocates a character image such as a telop to the mask layer 710 and allocates a photograph or a CG image to the image layer 720, thereby to create each frame 700.

When encoding each frame having the mask layer 710 and the image layer 720 in such a manner, as exemplarily shown in FIG. 13B, the image processing device 2 encodes each frame in an order of the mask layer and the image layer and generates a code stream (the single stream) in which code data of the mask layer and code data of the image layer are alternately arranged.

In this case, when generating code data of the image layer 720′ of a current frame 700′, the encoding program 5 refers to the image layer 720 of a previous frame 700 having been skipped over one frame to perform the inter-frame prediction. Accordingly, the image layer 720′ is efficiently decoded. Further, when generating code data of the mask layer 710′ of the current frame 700′, the encoding program 5 refers to the mask layer 710 of the previous frame 700 having been skipped over one frame to perform the inter-frame prediction and refers to the image layer 720′ of the current frame 700′ to perform an inter-layer prediction. Here, the inter-layer prediction is a prediction process which is performed by referring another layer image in the same frame. For example, the inter-layer prediction is realized by the in-frame prediction unit 510 which refers to another layer image.

Further, when encoding each frame having the mask layer 710 and the image layer 720, as exemplarily shown in FIG. 13C, the image processing device 2 may classify the mask layer and the image layer belonging to each frame according to the layer attribute and may perform the encoding process for each layer classified. In this case, the code stream (the multi-stream) in which code data of the mask layer and code data of the image layer are arranged in parallel is generated.

In this case, when generating code data of the image layer 720′ of the current frame 700′, the encoding program 5 refers to the image layer 720 of the previous frame 700 just before to perform the inter-frame prediction. Further, when generating code data of the mask layer 710′ of the current frame 700′, the encoding program 5 refers to the mask layer 710 of the previous frame 700 having been skipped over one frame to perform the inter-frame prediction. Accordingly, the mask layer and the image layer are efficiently compressed together.

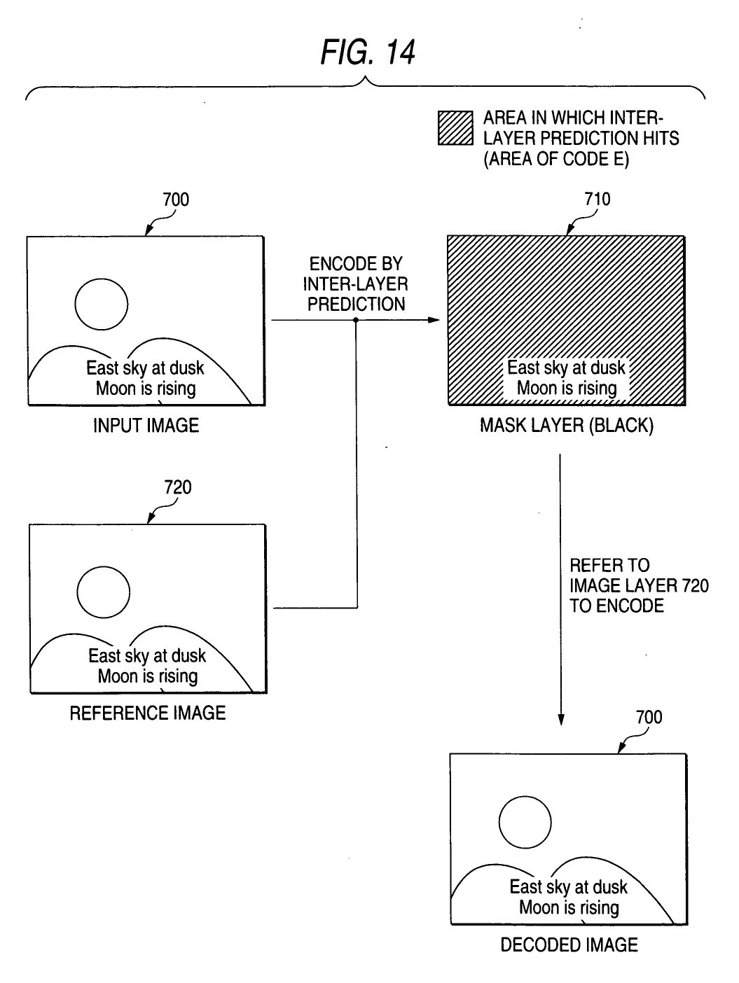

FIG. 14 is a diagram illustrating an encoding process to which the inter-layer prediction is applied.

As exemplarily shown in FIG. 14A, when generating code data of the mask layer 710, the encoding program 5 causes the in-frame prediction unit 510 to refers to the image layer 720 and processes image data of the frame 700. Thus, code data including codes of reference information with respect to the image layer 720 can be generated. Code data generated in such a manner becomes code data of the mask layer 710. In the encoded mask layer 710, a hatched area is an area in which the prediction (the inter-layer prediction) performed by referring to the reference image (the image layer 720) hits. This area is encoded as consecutive codes corresponding to the inter-layer prediction by the in-frame prediction unit 510.

Code data of the mask layer 710 is decoded by referring to the image layer 720, thereby generating the decoded image corresponding to the image of the frame 700.

As such, the encoding program 5 of the second modification generates code data of the mask layer 710 by using the inter-layer prediction and the inter-frame prediction in the same frame, and thus the high compression rate can be expected.

[Second Embodiment]

Next, a second embodiment will be described. Like slide images or the like, there is a file (hereinafter, referred to as a document file) that plural pages are consecutively output in quasi-static wise. Plural page images included in such a document file may have high correlation with each other.

Therefore, when encoding one page image (hereinafter, referred to as an object page) included in the document file, the image processing device 2 according to the second embodiment generates code data of the object page by means of the predictive encoding process in which another image different from the object page (for example, a template image described later or another page image) is referred to.

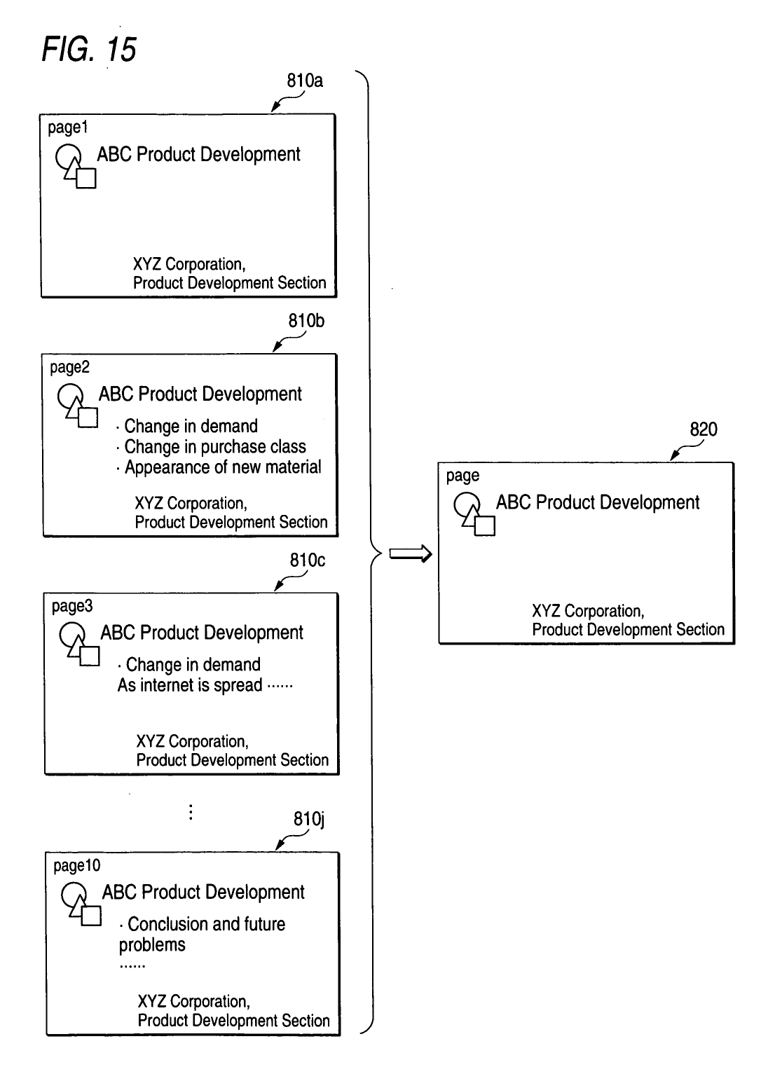

FIG. 15 is a diagram illustrating an encoding process of the document file having the plural pages.

As exemplarily shown in FIG. 15, the plural pages included in the document file commonly have a header portion (in the present embodiment, a page number), a title portion (in the present embodiment, characters of ‘ABC Product Development’), a logo mark, and a footer portion.

Therefore, the image processing unit 2 according to the present embodiment creates the template image 820 having the common portions in advance and generates code data of each page by means of the predictive encoding process which refers to the template image 820.

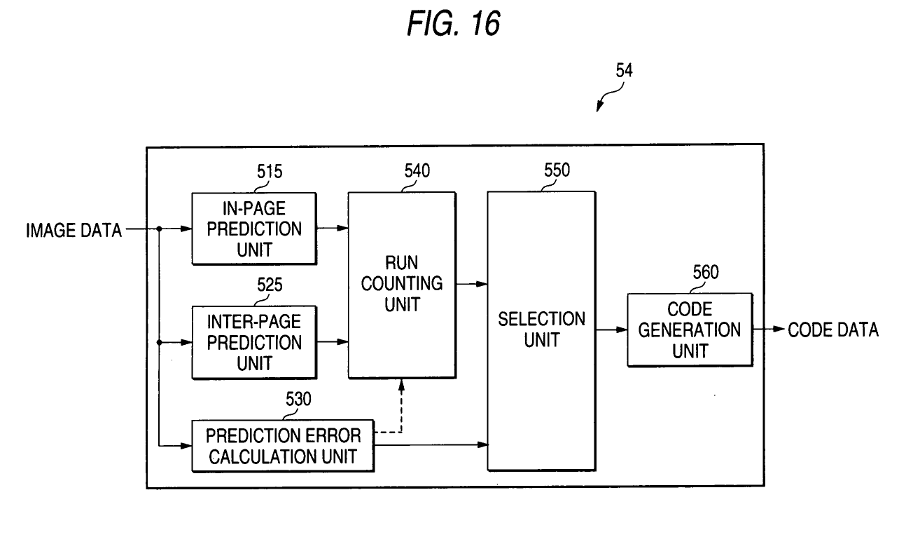

FIG. 16 is a diagram exemplarily showing a functional configuration of an encoding program 54 according to the second embodiment. Moreover, in FIG. 16, the substantially same elements as those of the configuration shown in FIG. 3 are represented by the same reference numerals.

As exemplarily shown in FIG. 16, the third encoding program 54 has a configuration in which the in-frame prediction unit 510 and the inter-frame prediction unit 520 in the first encoding program 5 are substituted with an in-page prediction unit 515 and an inter-page prediction unit 525 respectively and the reference position setting unit 570 is removed.

In the encoding program 54, the in-page prediction unit 515 refers to the pixel value of the reference position set on the page image (an object page) to be encoded, sets the pixel value to the prediction value, and outputs a comparison result of the prediction value and the pixel value of the pixel of notice to the run counting unit 540. For example, as exemplarily shown in FIG. 4A, the in-page prediction unit 515 compares the pixel value of each of the reference pixels A to D on the object page to the pixel value of the pixel of notice X to be encoded. If the pixel value of one of the reference pixels matches with the pixel value of the pixel of notice, the in-page prediction unit 515 outputs the prediction unit ID identifying the reference position to the run counting unit 540. To the contrary, if the pixel value of any one of the reference pixels does not match with the pixel value of the pixel of notice, the in-page prediction unit 515 outputs a purport that they do not match with each other to the run counting unit 540.

The inter-page prediction unit 525 refers to the pixel value of another image (hereinafter, referred to as a reference image) different from the object page, sets the pixel value of the reference frame to the prediction value, and outputs a comparison result of the prediction value and the pixel value of the pixel of notice (the pixel included in the object page) to the run counting unit 540. The inter-page prediction unit 525 of the present embodiment refers to the template image 820 exemplarily shown in FIG. 15 and compares the pixel value of the reference position on the template image 820 to the pixel value of the pixel of notice X. If both pixel values match with each other, the inter-page prediction unit 525 outputs the prediction unit ID identifying the reference position to the run counting unit 540. In other cases, the inter-page prediction unit 525 outputs a purport that both pixel values do not match with each other to the run counting unit 540. The reference position on the template image 820 corresponds to the relative position of the pixel of notice X on the object page. For example, when the resolution of the object page matches with the resolution of the template image 820, the reference position and the relative position of the pixel of notice X are the same. Moreover, when generating code data of the object page, the inter-page prediction unit 525 may refer to another page to perform the prediction process.

As described above, when encoding the object page included in the document file, the image processing device 2 according to the second embodiment refers to another image (the template image 820 or another page image) to perform the predictive encoding process, such that the object page can be encoded with high compression rate. Further, when decoding code data generated in such a manner, the image processing device 2 refers to another image (the template image 820 or another page image) according to code data, such that the decoded image can be more efficiently generated.

[Other Modifications]

Next, another specified embodiment to which the present invention can be applied will be described.

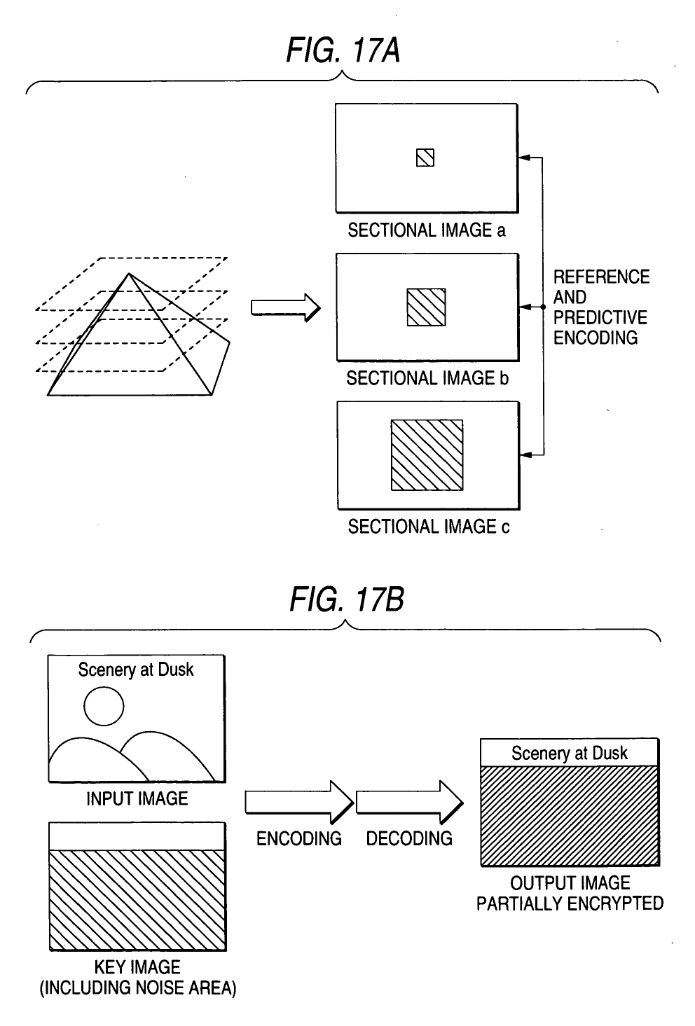

FIG. 17A is a diagram illustrating an encoding process of a three-dimensional (3D) motion picture and FIG. 17B is a diagram illustrating an encoding process which executes an encryption process to the motion picture.

As exemplarily shown in FIG. 17A, the respective frame images constituting the 3D motion picture include a cubic shape and each cubic shape has plural sectional images. In general, the sectional images have the high correlation with each other. For this reason, the present invention can be applied to the encoding process of the sectional images.

For example, when encoding one sectional image of the cubic shape of the current frame as a sectional image of notice, the image processing device 2 uses the prediction process which refers to another sectional image of the current frame and the inter-frame prediction process which refers to a sectional image of a cubic shape of another frame together, such that the sectional image of notice can be encoded with high compression rate.

Further, as exemplarily shown in FIG. 17B, the image processing device 2 refers to the reference image including a noise area to encode the respective frame images constituting the motion picture, such that an inspection control to the motion picture can be performed. For example, if the respective frame images are encoded with a key image in which an area corresponding to an area to be encrypted (hereinafter, an encryption area) includes noise, the encryption area of each of the frame images is encoded with reference to noise. For this reason, the prediction randomly (ununiformly) hits with the pixel value of the key image and the codes of reference information with respect to the key image are randomly inserted into code data of the frame image. Thus, if code data is decoded without using the key image, the area corresponding to the noise area (the encryption area) becomes a scrambled image and consequently is decoded. On the other hand, an area to be not encrypted (a non-encryption area) is encoded with reference to an area which is filled with a predefined pixel value (for example, the minimum or maximum) uniformly. Therefore, even when the decoding process is performed without using the key image, the motion picture is reproduced in an inspectable state.

The entire disclosure of Japanese Applications No. 2004-254084 filed on Sep. 1, 2004 including specifications, claims, drawings and abstracts is incorporated herein by reference in its entirety.

What is claimed is:

1. An encoding device to encode data of a motion picture made of a plurality of frame images comprising:
a reference information generating unit, based on image data of a frame image of notice to be encoded, that generates reference information with respect to another frame image different from the frame image of notice; and
a code generating unit that generates code data of the reference information generated by the reference information generating unit as code data of at least a portion of the frame image of notice.

2. The encoding device according to claim 1,
wherein, when encoding an area of notice of the frame image of notice, the reference information generating unit further generates reference information with respect to another area on the frame image of notice different from the area of notice, and
the code generating unit generates code data of the reference information with respect to another area on the frame image of notice or code data of the reference information with respect to another frame image, as code data of the area of notice.

3. The encoding device according to claim 1, further comprising:
a reference position setting unit that sets a reference position with respect to another frame image according to the frame image of notice,
wherein, based on image data of the reference position set by the reference position setting unit and image data of the area of notice in the frame image of notice, the reference information generating unit generates reference information with respect to the reference position.

4. The encoding device according to claim 3,
wherein the reference position setting unit changes the number of the reference positions according to the area of notice in the frame image of notice, and
the reference information generating unit selects one reference position among at least one reference position set by the reference position setting unit based on image data of the area of notice and image data of the reference position, and generates reference information with respect to the selected reference position.

5. The encoding device according to claim 3,
wherein the reference position setting unit changes the reference position in another frame image according to the area of notice in the frame image of notice, and
based on image data of the reference position set by the reference position setting unit and image data of the area of notice in the frame image of notice, the reference information generating unit generates the reference information with respect to the reference position.

6. The encoding device according to claim 3,
wherein, according to a difference between the frame image of notice and another frame image whose reference position is set, the reference position setting unit sets the reference position in another frame image.

7. The encoding device according to claim 1,
wherein the reference information generating unit compares image data of the area of notice in the frame image of notice to image data of a reference position in another frame image and, when a difference between the image data of the area of notice and the image data of the reference position falls within a first predefined tolerance, generates reference information with respect to the reference position, and
the code generating unit generates code data of the reference information generated by the reference information generating unit as code data of the area of notice.

8. The encoding device according to claim 7,
wherein the reference information generating unit compares image data of the area of notice in the frame image of notice to image data of another area in the frame image of notice and, when a difference between image data of the area of notice and image data of another area falls within a second predefined tolerance, generates reference information with respect to another area, and
the first tolerance with respect to the difference between image data of the area of notice in the frame image of notice and image data of the reference position in another frame image is different from the second tolerance with respect to the difference between image data of the area of notice and image data of another area in the frame image of notice.

9. The encoding device according to claim 7, further comprising:
a data substituting unit that compares image data of the area of notice in the frame image of notice to image data of the reference position in another frame image and, when the difference between image data of the area of notice and image data of the reference position falls within the first predefined tolerance, and substitutes image data of the area of notice with image data of the reference position.

10. The encoding device according to claim 7, further comprising:
a data substituting unit that substitutes image data of the area of notice with a statistical value of image data of the reference position when the difference between image data of the area of notice and image data of the reference position of another frame image among the plurality of frame images consecutively falls within the first predefined tolerance.

11. The encoding device according to claim 1,
wherein each of the frame images has at least a first layer image and a second layer image,
when encoding the first layer image constituting the frame image of notice, the reference information generating unit generates reference information with respect to a first layer image constituting another frame image, and
the code generating unit generates code data of the reference information with respect to the first layer image constituting another frame image as code data of at least a portion of the first layer image constituting the frame image of notice.

12. An encoding device to encode data of a document file including a plurality of page images comprising:
a reference information generating unit, based on image data of a page image to be encoded, that generates reference information with respect to a reference image different from the page image; and
a code generating unit that generates code data of the reference information generated by the reference information generating unit as code data of at least a portion of the page image.

13. The encoding device according to claim 12,
wherein the reference image is another page image different from the page image to be encoded,
the reference information generating unit generates reference information with respect to another page image, and
the code generating unit generates code data of the reference information with respect to another page image as code data of at least a portion of the page image to be encoded.

14. The encoding device according to claim 12,
wherein the reference image is a common object image which commonly exists in the plurality of page images,
the reference information generating unit generates reference information with respect to the common object image, and
the code generating unit generates code data of the reference information with respect to the common object image as code data of at least a portion of the page image to be encoded.

15. A decoding device to decode code data of a motion picture made of a plurality of frame images comprising:
a reference data extracting unit, based on code data of a frame image of notice, that refers to another frame image different from the frame image of notice and that extracts image data included in another frame image; and
an image data generating unit, based on the image data extracted by the reference data extracting data, that generates image data of at least a portion of the frame image of notice.

16. An encoding method to encode data of a motion picture made of a plurality of frame images comprising:
generating, based on image data of a frame image of notice to be encoded, reference information with respect to another frame image different from the frame image of notice; and
generating code data of the generated reference information as code data of at least a portion of the frame image of notice.

17. A decoding method to decode code data of a motion picture made of a plurality of frame images comprising:
referring, based on code data of a frame image of notice, to another frame image different from the frame image of notice and extracting image data included in another frame image; and
generating, based on the extracted image data, image data of at least a portion of the frame image of notice.

18. An encoding program for realizing a processing to an encoding device to encode data of a motion picture made of a plurality of frame images, the encoding method comprising:
generating, based on image data of a frame image of notice to be encoded, reference information with respect to another frame image different from the frame image of notice; and
generating code data of the generated reference information as code data of at least a portion of the frame image of notice.

19. A decoding program for realizing a processing to a decoding device to decode code data of a motion picture made of a plurality of frame images, the decoding method comprising:
referring, based on code data of a frame image of notice, to another frame image different from the frame image of notice and extracting image data included in another frame image; and
generating, based on the extracted image data, image data of at least a portion of the frame image of notice.
